(19) United States
(12) Patent Application Publication
(10) Pub. No.: US 2009/0277400 A1
(43) Pub. Date: Nov. 12, 2009

(54) Rankine cycle heat recovery methods and devices

(76) Inventor: Ronald David Conry, Tallahassee, FL (US)

Correspondence Address: WILEY HORTON, 215 SOUTH MONROE STREET, 2ND FLOOR, TALLAHASSEE, FL, 32301, US

(21) Appl. No.: 12/387,664

(22) Filed: May 6, 2009

Related U.S. Application Data
(60) Provisional application No. 61/126,603, filed on May 6, 2008.

(51) Int. Cl. F02B 63/00; F01P 3/22; F01P 7/00; F02B 33/00; F01K 25/08; F01D 15/10

(52) U.S. Cl. 123/2; 123/41.19; 123/41.08; 123/559.1; 60/651; 290/52

(57) ABSTRACT

An integrated expansion turbine/electrical generator assembly (collectively referred to as a “turbo-generator”) suitable for use in waste heat recovery and similar applications. The turbo-generator uses a common shaft mounting a one or more stage expansion turbine and a homopolar electrical generator. Magnetic levitating axial and thrust bearings are used to hold the common shaft in its proper position with a fixed housing. The magnetic bearings minimize frictional losses, allowing the common shaft to spin at a very high rotational velocity. Sensor rings continually monitor the common shaft's position. This information is used by control electronics to regulate the magnetic bearings in order to hold the rotating shaft's position. Electrical energy is extracted from the rotating shaft in the form of a direct current. Preferably integrated power-switching electronics are used to generate single or three-phase AC power, which can be phase-matched to an existing power grid or other application.

### CROSS-REFERENCES TO RELATED APPLICATIONS

Pursuant to 37 C.F.R. §1.53(c), this is a non-provisional application claiming the benefit of an earlier-filed provisional application. The provisional application was filed on May 6, 2008 and was assigned Ser. No. 61/126,603. It listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

The present invention relates to the fields of power generation and waste heat recovery. More specifically, the invention comprises a combined expansion turbine and electrical generator configured for use in waste heat recovery Rankine cycles.

2. Description of the Related Art

Many common industrial machines must reject “waste heat” to the surrounding atmosphere in order to operate. While this phenomenon is well understood by those familiar with the laws of thermodynamics, some simple examples may be helpful in illustrating the concept. FIG. 1 shows a simple depiction of the Rankine cycle. This cycle is typically employed in steam-based power generating plants.

The upper view is a schematic depiction of the major components. The lower view shows a temperature-entropy diagram (a “state diagram”). The cycle begins at point “1.” At this point the steam has been condense back to liquid water and is then pulled into pump 18. Pump 18 pressurizes the liquid water and feeds it into boiler 10 (point “2” in the diagrams). External heat is applied to boiler 10 to raise the water to its boiling temperature (which will of course vary according to the pressure applied by the pump). All the water is converted to steam and fed out of the boiler (point “3” in the diagrams). The steam is then fed into turbine 12, which expands the steam in order to extract mechanical energy to drive generator 14.

The steam exits the turbine at state “4.” At this point the steam is of a reduced quality and may even contain a small percentage of condensed liquid (though the amount of condensed liquid is generally minimized because of its destructive influence on turbine life). The low quality steam cannot be fed directly to the pump, since it is impractical to design a pump which will effectively handle a mixture of liquid and vapor. Accordingly, the steam must be converted back to a homogenous liquid. Condenser 16 is used for this purpose. The condenser rejects heat to the surrounding atmosphere and condenses all the working fluid back to water. The working fluid exiting the condenser returns to point “1” and the cycle repeats.

The state diagram depicted is idealized, since it shown compression in the pump and expansion in the turbine as isentropic processes. This is, of course, never actually the case. Heat is always transferred in these processes and frictional losses always occur. However, the idealized state diagram is useful for comparing steam to other possible working fluids—as will become apparent.

A greater expansion ratio through the turbine generally extracts more of the energy available in the cycle and increases turbine efficiency. However, in steam cycles, the ability to increase the expansion ratio is always limited. When the steam pressure drops below a certain point condensation begins to occur. Condensation in the turbine will eventually produce water droplet formation. The water droplets—in turn—can impinge upon the turbine blades and substantially reduce the turbine's life. Thus, when steam is used as a working fluid, the cycle designer generally reduces the turbine expansion ratio well below what would otherwise be optimal.

As one would expect, prior art cycle designer have sought to eliminate the problem of condensation in the turbine. The first and most obvious modification over the cycle of FIG. 1 is to superheat the steam. This allows additional expansion without condensation. Superheating is also conventionally used with the “Reheat Cycle,” which is shown in FIG. 2. Points “1” through “3” are the same as for the basic Rankine cycle. However, the turbine is split into two stages to form two stage turbine 20. Steam is extracted from the turbine's first stage at point “4” and sent back through the boiler. It emerges from the boiler having returned to a superheated state at point “5.” This superheated steam is then fed into the turbine's second stage. It emerges expanded to the state at point “6.” The steam then goes through condenser 16 and returns to the pump as for the simple Rankine cycle. The use of reheat allows a greater overall expansion ratio across the turbine. However, it also increases complexity and cost.

FIG. 3 shows a variation on the Rankine cycle which is generally referred to as the “regenerative cycle.” When using superheated steam turbine cooling can be a problem. Excess heat may be carried away by a separate working fluid. However, it is advantageous to recover this heat and use it in the cycle. The regenerative cycle achieves this in part. Pressurized water leaving pump 18 is shown passing through point “2” on the schematic and state diagrams. It then passes through a cooling jacket surrounding the turbine. Some of the heat transferred from the steam to the turbine is thereby used to “preheat” the pressurized water heading into boiler 10. This can produce increased efficiency. The reader will note that superheat is not employed in the example shown. This need not be the case. Superheat can be used in such a cycle. In fact, actual heat engines tend to combine features of two or more of the simple cycles discussed herein.

FIG. 4 shows a more complex Rankine cycle which is referred to as a “practical regenerative cycle.” Beginning at point “1,” condensed water is pressurized by low pressure pump 22. It is then fed into feedwater heater 24, where it is combined with relatively high quality steam bled from the high pressure stage of two stage turbine 20 (at point “6”). Enough high pressure steam is added to significantly raise the temperature of the resulting combination, but not enough to produce a significant quantity of vapor. In other words, when the combination emerges to point “3,” it is all liquid. This liquid then passes through high pressure pump 26, where it is raised to the boiler's operating pressure at point “4.”

The water is then converted to steam by point “5.” As mentioned previously, some of the steam is bled from the turbine's first stage. However, most of the steam passes through both turbine stages and then to point “7.” This steam then passes through condenser 16 and returns to point “1.” The more complex temperature-entropy diagram is reflective of the fact that the cycle includes multiple loops. Rankine cycles used in actual power production tend to be still more complex. Steam may be bled out of the turbine and sent to feedwater heaters at two, three, or more points. The pressurization of the feedwater is likewise accomplished in multiple stages.

Rankine cycle engines have long been considered for application to the field of waste heat recovery. However, the use of steam as a working fluid is not generally suitable for these applications. A typical waste heat source has a relatively low temperature—in the neighborhood of 200 degrees Celsius. Such a low temperature heat source simply cannot impart substantial specific energy to steam. This results from steam's relatively low molecular weight. Water has molecular mass of 18.02 g/mol. Thus, in order to operate a Rankine cycle engine on low temperature steam, a very high volume of steam must be used. This ultimately becomes impractical.

In contrast, some of the chloro and fluoro substituted hydrocarbons used in refrigeration cycles have a relatively high molecular weight. Pentafluoropropane is one good example. This compound, which is commercially known as R-245fa, has a molecular mass of 134 g/mol. Such a high density allows good energy transport at relatively low volumes. Thus, high molecular weight organic compounds have long been identified for use in Rankine cycle engines intended for waste heat recovery.

Rankine cycles employing a high molecular weight organic compound for a working fluid have come to be known as “organic Rankine cycles,” or “ORC's.” This term is somewhat misleading, since an organic Rankine cycle is simply a Rankine cycle employing an organic working fluid. It is not, in fact, a separate type of cycle. However, this disclosure will adhere to the convention of referring to the use of an organic working fluid in a Rankine cycle as an “organic Rankine cycle.”

Organic Rankine cycles have traditionally been designed under many of the same principles developed for steam operation. They have also employed components designed for steam operation—particularly expensive components such as turbines. The result has not been optimal, since organic working fluids are inherently different from steam.

FIG. 5 depicts a representative organic Rankine cycle and associated temperature-entropy diagram. The working fluid shown is toluene (methyl benzene). Toluene has a molecular mass of 92.14 g/mol and a boiling point of 110.6 degrees Celsius. These characteristics—especially its relatively high boiling point—make it attractive for certain heat recovery applications. The reader will immediately observe, however, the odd shape of the T-s curve shown at the bottom of FIG. 5. The right portion of the curve actually has a negative slope.

Those familiar with steam thermodynamics will immediately recognize this difference and its implications. However, an explanation in the context of the components used in the cycle will be helpful. The explanation will commence at point “3” in the cycle, since this portion of the operation is the same as steam-based Rankine cycles. At point “3,” all the toluene has been converted to a gas and has in fact been superheated along the curve shown in the state diagram. It is then expanded through turbine 12 to a much lower pressure, emerging at point “4.” At this point the differences to a steam-based cycle become apparent. The negative slope of the T-s curve in the region proximate points “3” and “4” means that expanding the gas through the turbine cannot cause condensation. The turbine exhaust will remain superheated—even though the pressure and temperature have dropped dramatically. This phenomenon opens the possibility of having a turbine with a very high expansion ratio, and this phenomenon is in fact something the present invention seeks to exploit.

It is generally necessary to convert the working fluid to a liquid state prior to feeding it into the pump. For a high molecular mass compound, this can generally not be done through a compressor alone. Thus, an altered type of regenerative cycle is used. A recuperator 27 is added in the line between points “4” and “4′.” The recuperator is a liquid to gas heat exchanger. Heat is transferred from the gas traveling between turbine 12 and condenser 16 to the liquid traveling between pump 18 and boiler 10. Thus, the gas is cooled prior to entering the condenser. Likewise, the compressed liquid is preheated before entering the boiler.

By the time the gas leaves the recuperator (point “4′”) very little superheat remains. The condenser is then able to completely condense the liquid before it exits on its way to the pump (point “1”). The pump then pressurizes the liquid to point “2,” after which it passes through the recuperator and on through boiler 10. The use of a recuperator—which is sometimes referred to as a “de-superheater”—is often necessary for an ORC engine.

Many organic compounds have been considered for use in ORC engines. The selection of a particular working fluid depends upon the waste heat temperature available, the cost of the working fluid, the expected life of the working fluid, potential toxicity, and other factors. The ideal working fluid would have a small heat capacity (low enthalpy), a critical temperature lying above the temperature of the waste heat source, an acceptable operating pressure, and a relatively high density in the gaseous state. TABLE I below summarizes the characteristics of some potential ORC working fluids (“F.P.” stands for freezing point and “B.P.” stands for boiling point”.

TABLE I

| | | Mol. Wt. | | B.P. |
|---|---|---|---|---|
| Common Name | IUPAC Name | (g/mol) | F.P. (° C.) | (° C.) |
| R-22 | chloro-difluoro methane | 86 | −135 | −40.8 |
| R-114 | 1,2-dichloro-1,1,1,2- | 171 | −94 | 3.6 |
| | tetrafluorethane | | | |
| R-133a | 1-chloro-1,1,1-trifluoro | 118 | −106 | 6.9 |
| | ethane | | | |
| R-134a | 1,1,1,2-tetrafluoro- | 102.03 | — | −26.5 |
| | ethane | | | |
| ammonia | ammonia | 17.03 | −77.7 | −33.4 |
| toluene | methyl benzene | 92.1 | −95 | 110 |
| butane | butane | 73.1 | −138.4 | −0.5 |
| Dowtherm E | 0-dichlorobenzene | 166 | −48 | |
| Genetron 245fa | 1,1,1,3,3-pentafluoro- | 134 | | 15.3 |
| | propane | | | |

Some manufacturers have experimented with the concept of mixing various organic working fluids to form stable azeotropes. This approach can modify the slope on right side of T-s diagram by mixing a candidate having a negative slope (such as R-134a) with one having a positive slope (such as water). A near-vertical slope can be achieved, though such an azeotrope's long term thermal stability is questionable.

No single working fluid will be suitable for all applications. In fact, the proposed applications cover a wide range of differing temperatures. It is therefore likely that a particular working fluid or fluids will be favored for a particular application. A non-exhaustive listing of the potential applications for the present invention is presented below. The stated waste heat temperature s generally not the temperature of the waste heat itself, but rather the expected temperature of a circulating fluid which carries the thermal energy from the waste heat source to the boiler in the Rankine cycle engine. The temperature of this circulating fluid must of course be lower than the temperature of the waste heat source itself.

TABLE II

| Application | Waste Heat Temp. Range (° C.) |
|---|---|
| Internal Combustion Engine Exhaust | 300-450 |
| Geothermal Energy Recovery | 125-200 |
| Chemical Plant Waste Heat | 200-350 |
| Petrochemical Flare | 300-450 |
| Landfill Flare | 200-300 |
| Metal Sintering Waste Heat | 200-300 |
| Solar Collectors | 100-300 |

Comparing TABLE I with TABLE II provides some understanding of the working fluid selection process. It will be apparent that a conventional refrigerant like R-134a is potentially suitable for low temperature applications, while toluene may be required for high temperature applications. Many other considerations must obviously go into the selection of a working fluid—including careful considerations of toxicity in the event of a system leak—but the information provided should give the reader a general understanding.

Returning briefly to FIG. 5, some additional principles regarding working fluid selection will be explained. Critical point 74 represents the temperature above which the working fluid—in this case toluene—cannot be liquefied no matter how much pressure is applied. There is of course a critical pressure associated with the critical temperature at this point. The critical pressure is the amount of pressure required to liquefy the working fluid at the critical temperature. The boiler operating temperature must obviously be below this point. The boiler operating temperature must also be below the temperature of the waste heat source. However, as those skilled in the art will know, the area within the loop on the T-s diagram represents the energy transferred by the cycle. Thus, it is desirable to place the boiler operating conditions in the vicinity of the critical point, and to place the condenser operating conditions as far below this point as practical.

The upper horizontal line in the state diagram is labeled as boiler temp./press. 76. This line represents the temperature and pressure present during the phase change of the working fluid from a liquid to a gas in the boiler (The superheating phase generally requires a separate superheater, though this is not shown separately in the schematic views). During the phase change in the boiler, pressure and temperature are constant. All the thermal energy coming in goes to gasifying the working fluid.

The lower horizontal line is labeled condenser temp./press. 78. This line represents the temperature and pressure present during the phase change of the working fluid from a gas back to a liquid in the condenser. During this phase change the temperature and pressure are again constant.

The reader will thereby appreciate that the selection of the working fluid will initially be driven by a comparison of the available waste heat temperature to the temperature-entropy state diagram for each candidate fluid. This will quickly determine the possible candidates. From this point the designer may then proceed to consider thermal stability, toxicity, and other factors. The reader will note that among the list of conventional refrigerant working fluids, R-245fa is well-suited to most waste heat recovery applications since it has a relatively high critical temperature.

Rankine cycle engines operating in the temperature ranges associated with waste heat recovery require little adjustment and supervision. In fact, several completely unmanned facilities have been operated for collecting geothermal energy at remote sites. These engines have been relatively expensive to build, however. As the energy output is modest, the payback period for constructing such a facility can be lengthy.

One of the reasons for the lengthy payback period is the required optimization of expensive components such as the expansion turbine. A modular turbine-generator combination that could be adapted for use with different working fluids at different flow rates, pressures, and temperatures would be highly advantageous in this field. The present invention comprises such a device.

### BRIEF SUMMARY OF THE INVENTION

The present invention is an integrated expansion turbine/electrical generator assembly (collectively referred to as a “turbo-generator”) suitable for use in waste heat recovery and similar applications. The turbo-generator uses a common shaft mounting a one or more stage expansion turbine and an electrical generator. Oilless axial and thrust bearings are used to hold the common shaft in its proper position within a fixed housing. The oilless bearings are preferably of the magnetic or foil type. They minimize frictional losses, allowing the common shaft to spin at a very high rotational velocity.

Sensor rings preferably monitor the common shaft's position. If magnetic bearings are employed, the sensor information is used by control electronics to regulate the magnetic bearings in order to hold the rotating shaft's position. Electrical energy is extracted from the rotating shaft in any suitable form, with three-phase AC power being the desired form. Switching power devices are preferably added to allow the production of AC power having a desired frequency at different shaft rotational velocities.

The turbo-generator is preferably of modest size and mass, so that it may be easily transported. It is also preferably of modular design, so that two or more turbo-generators can be run in parallel. In some applications, it is also preferable to run two or more such turbo-generators in a series connection so that they can accommodate multi-expansion Rankine cycles.

### BRIEF DESCRIPTION OF THE SEVERAL VIEWS OF THE DRAWINGS

FIG. 1 is a schematic view, showing the components of a Rankine cycle engine along with a temperature-entropy diagram.

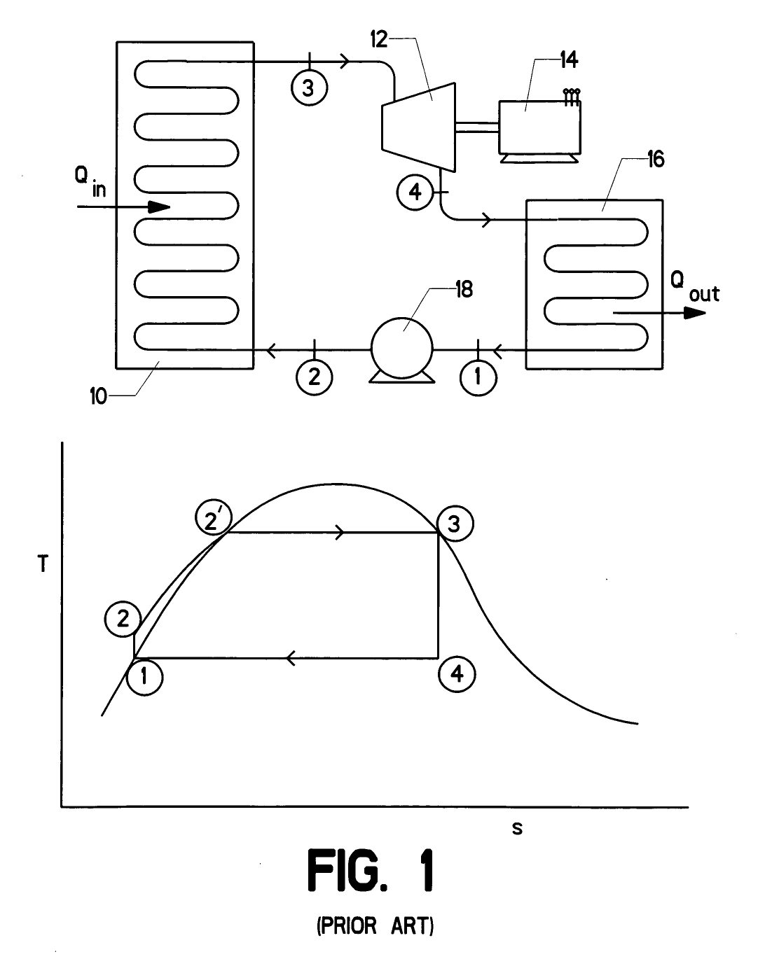

FIG. 2 is a schematic view, showing the components of a Rankine cycle engine with the addition of reheat, along with a temperature-entropy diagram.

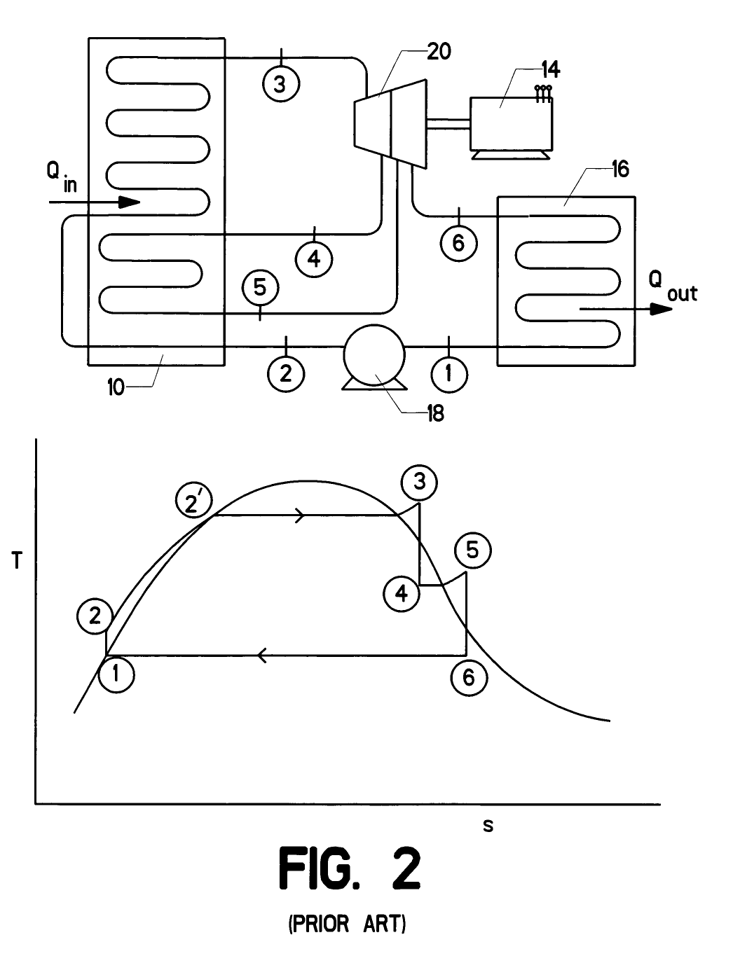

FIG. 3 is a schematic view, showing an idealized regenerative cycle, along with a temperature-entropy diagram.

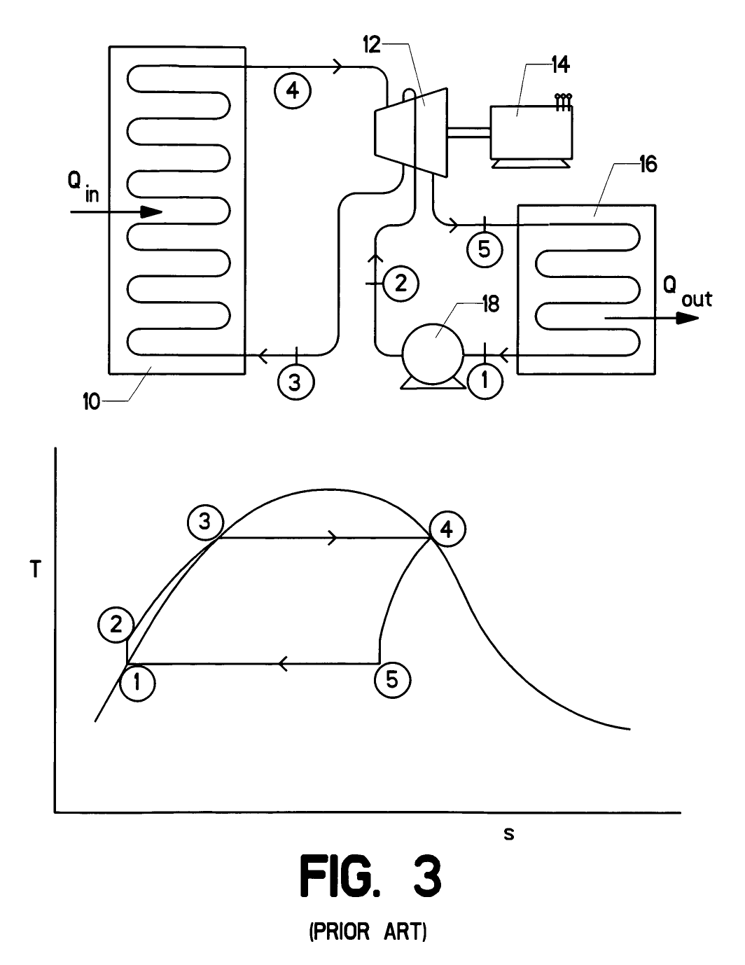

FIG. 4 is a schematic view, showing a more practical regenerative cycle, along with a temperature-entropy diagram.

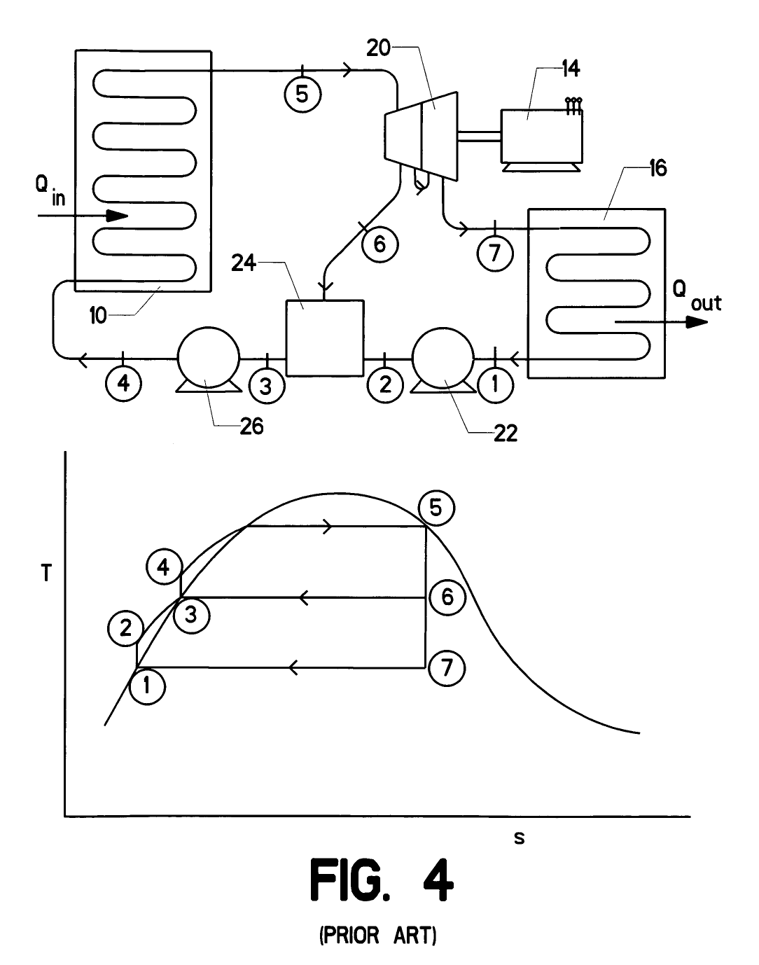

FIG. 5 is a schematic view, showing the components of a Rankine cycle engine configured for use with an organic working fluid having a high molecular weight, along with a temperature-entropy diagram.

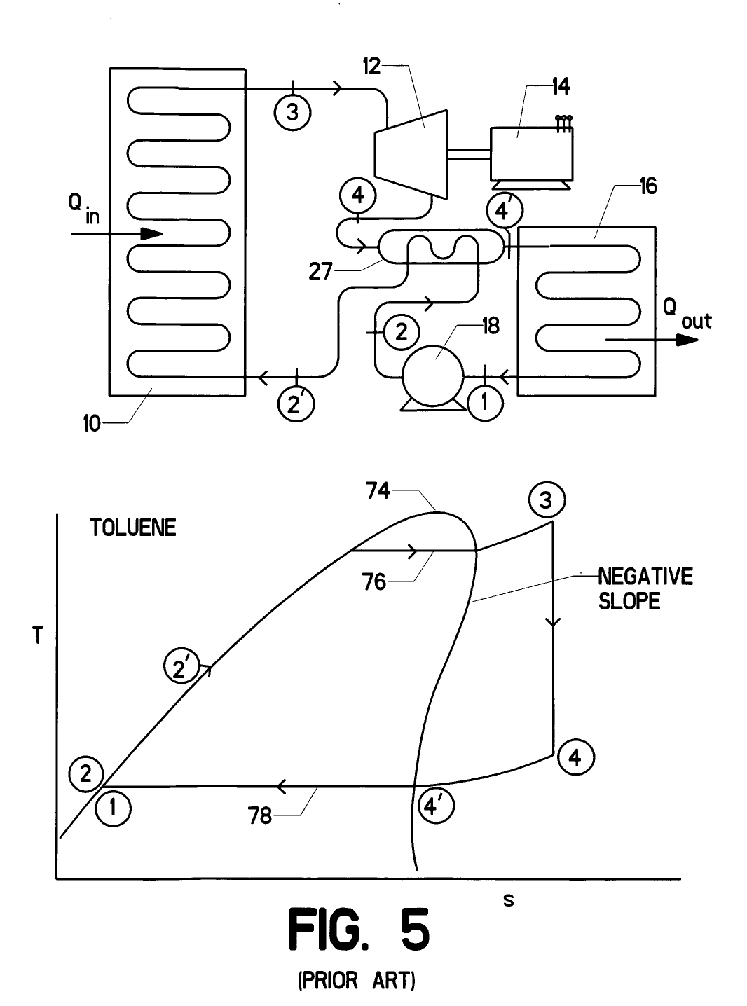

FIG. 6 is a sectioned elevation view, showing some internal components of the present invention.

FIG. 7 is a schematic view, showing the components needed to create an alternating current output.

FIG. 8 is a plot of output voltage.

FIG. 9 is a plot of output voltage, showing how pulse width modulation can be employed to create sinusoidal voltage.

FIG. 10 is a plot of output voltage, showing how the dwell of each pulse can be used to regulate the amplitude of the output voltage.

FIG. 11 is a plot of output voltage, showing how the dwell of each pulse can be used to regulate the amplitude of the output voltage.

FIG. 12 is a schematic view, showing the use of multiple turbo-generators in parallel in a waste heat recovery engine.

FIG. 12B is a schematic view, showing an alternate arrangement for applying the output of one or more turbo-generators to an existing power grid.

FIG. 13 is a schematic view, showing the use of multiple turbo-generators in series in a waste heat recovery engine.

FIG. 14 is a schematic view, showing the use of an internal combustion engine as a heat source.

FIG. 14B is a schematic view, showing the addition of exhaust heat recovery to the device of FIG. 14.

FIG. 15 is a schematic view, showing the use of circulating refrigerant to directly cool an internal combustion engine.

FIG. 16 is a schematic view, showing the use of transfer tanks to eliminate the need for a pump in a heat engine.

FIG. 17 is a schematic view, showing the operation of the system of FIG. 16.

FIG. 18 is a schematic view, showing the use of piston pumps in a heat engine.

FIG. 18B is a schematic view, showing one of the piston pumps in more detail.

FIG. 19 is a schematic view, showing the addition of a supercharger to the intake system of the internal combustion engine.

FIG. 20 is a schematic view, showing the use of the turbo-generator to power a drive motor.

### REFERENCE NUMERALS IN THE DRAWINGS

| | | | |
|---|---|---|---|
| 10 | boiler | 12 | turbine |
| 14 | generator | 16 | condenser |
| 18 | pump | 20 | two-stage turbine |
| 22 | low pressure pump | 24 | feed water heater |
| 26 | high pressure pump | 27 | recuperator |
| 28 | generator | 30 | common shaft |
| 32 | homopolar motor | 34 | front sensor ring |
| 36 | front bearing | 37 | middle bearing |
| 38 | rear sensor ring | 39 | middle sensor ring |
| 40 | rear bearing | 42 | thrust bearing |
| 44 | thrust plate | 46 | turbine inlet |
| 48 | high pressure stage | 49 | first stage collector |
| 50 | low pressure stage | 51 | second stage collector |
| 52 | turbine outlet | 53 | bleed outlet |
| 54 | control electronics | 56 | DC to AC converter |
| | | | (**GONE?** |
| 58 | electrical load | 60 | DC voltage |
| 62 | desired AC output | 64 | pulse |
| 66 | turbo-generator | 68 | waste heat source |
| 70 | pump | 72 | circulation loop |
| 74 | critical point | 76 | boiler temp./press. |
| 78 | condenser temp./press. | 80 | splitter valve |
| 82 | motor windings | 84 | cooling jacket |
| 86 | internal combustion engine | 88 | coolant pump |
| 90 | thermostat | 92 | heat exchanger/boiler |
| 94 | turbo-generator | 96 | condenser/radiator |
| 98 | first transfer tank | 100 | second transfer tank |
| 102 | first vent line | 104 | second vent line |
| 105 | third vent line | 107 | fourth vent line |
| 106 | first pressure line | 108 | second pressure line |
| 110 | first tee | 112 | second tee |
| 113 | third tee | 114 | first vent valve |
| 115 | fourth tee | 116 | second vent valve |
| 117 | third vent valve | 118 | first pressure valve |
| 119 | fourth vent valve | 120 | second pressure valve |
| 121 | fifth vent valve | 122 | first check valve |
| 123 | sixth vent valve | 124 | second check valve |
| 125 | seventh vent valve | 126 | third check valve |
| 127 | eighth vent valve | 128 | fourth check valve |
| 130 | first piston pump | 132 | second piston pump |
| 133 | first piston | 134 | second piston |
| 136 | first chamber | 138 | second chamber |
| 140 | third chamber | 142 | first intake line |
| 144 | second intake line | 146 | fifth vent line |
| 148 | sixth vent line | 150 | seventh vent line |
| 152 | eighth vent line | 154 | super charger |
| 156 | ring motor | 158 | exhaust manifold |
| 160 | exhaust heat exchanger | 162 | rectifier |
| 164 | IGBT module | 166 | AC grid |
| 168 | output power electronics module | | |

### DETAILED DESCRIPTION OF THE INVENTION

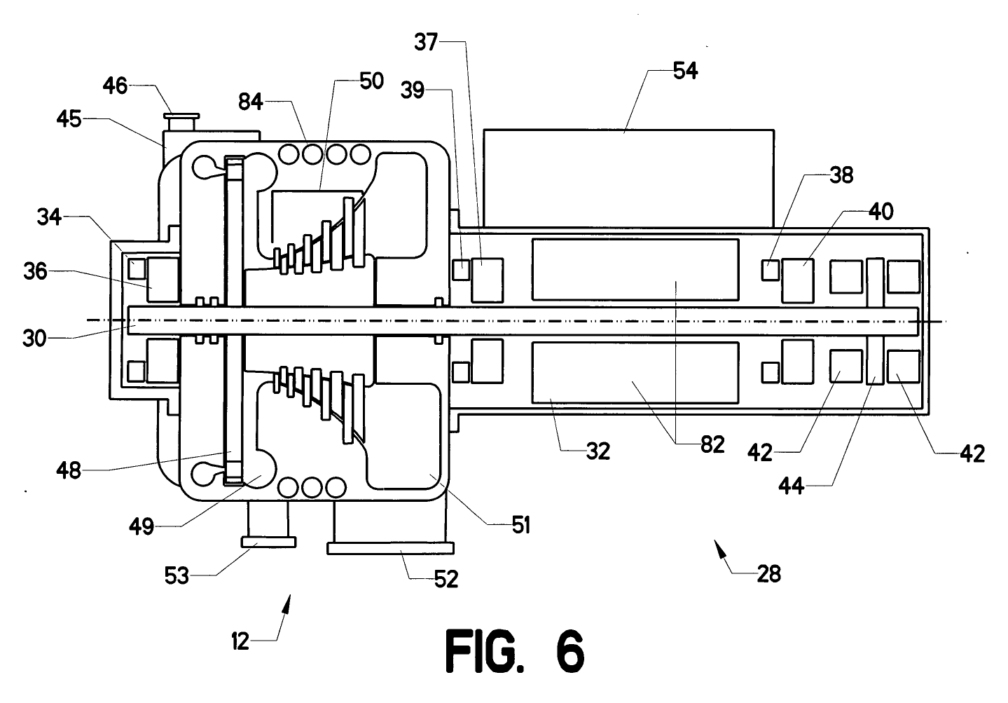

FIG. 6 shows an integrated expansion turbine 12 and generator 28, which are collectively referred to as turbo-generator 66. The turbo-generator is specially configured for efficient use with heat recovery cycle engines. Though it is not limited to organic Rankine cycle engines, many of its applications will lie in that field.

The turbo-generator is preferably able to operate over a wide range of rotational speeds and expansion ratios. It is preferably also able to handle a variety of working fluids, including fairly aggressive chemicals such as toluene. Common shaft 30 extends from one end of the device to the other. It is supported by two or more bearings, which are oilless bearings, preferably of the foil or electromagnetic type. The bearings can be located in a variety of suitable positions, such as front bearing 36, middle bearing 37, and rear bearing 40 in FIG. 6.

If electromagnetic bearings are used, then the common shaft will likely be suspended using only two bearings, since it is difficult to align and balance three electromagnetic bearings (Three bearing and sensor ring positions are shown in FIG. 6, but it is likely that only two of the three positions will actually be present in a working embodiment).

Front sensor ring 34 provides rapidly updated information regarding the position of the portion of common shaft 30 passing through front bearing 36. Middle sensor ring 39 provides the same function for the middle portion of the shaft. Rear sensor ring 38 provides comparable information regarding the position of the rotating shaft relevant to rear bearing 40. Control electronics utilize the information obtained from the sensor rings to rapidly update the electromagnetic forces produced by the front and rear bearings, thereby maintaining the common shaft in a suspended position which minimizes friction.

Since the common shaft may be driven by a turbine having axial flow (or at least one stage having axial flow), substantial thrust loads are a possibility which must be accounted for. Thrust plate 44—which rotates with the common shaft—is sandwiched between a pair of thrust bearings 42. These are also oilless and preferably electromagnetic or foil bearings. If an electromagnetic bearing is employed, the rear sensor ring is used to monitor displacements parallel to the common shaft's central axis. This information is used to update the electromagnetic forces applied by the two thrust bearings and thereby maintain the proper position of thrust plate 44.

Conventional bearings can be substituted for the electromagnetic bearings. Simple conventional bearings are preferably provided in parallel with the electromagnetic bearings so that the common shaft can be safely decelerated and parked in the event of a power failure. A more thorough description of the electromagnetic bearings and associated control technology is disclosed in U.S. Pat. Nos. 5,857,348 and 7,240,515 to Conry and U.S. Pub. No. 2005/0223737 to Conry. The techniques for safely decelerating the rotor and “parking” the bearings are described in U.S. Pat. No. 7,116,066 to Lin. These documents are hereby incorporated by reference.

In general, it is preferable to provide the power for the control electronics and bearings from the turbo-generator itself. When a shut-down of the system is initiated, the motor output can provide sufficient power as it spins down. One or more capacitors—or other energy storage devices—are preferably used to provide a brief period of available electrical power as the shaft is spinning to a stop. This allows a complete and safe shut-down. Of course, external power may also be used for this purpose.

FIG. 6 shows a two-stage expansion turbine. Both stages are attached to the common shaft on the left side of FIG. 6. Preferably superheated working fluid flows into turbine inlet 46. Its passage into the turbine stages may be regulated by a throttle assembly 45. Admitted working fluid passes through high pressure stage 48, which may be an impulse turbine of a radial configuration. The expanded working fluid is then collected in first stage collector 49. In many applications, the contents of first stage collector 49 will be fed directly into low pressure stage 50, where it will be further expanded. The low pressure stage may be an axial flow, reaction type turbine, or simply another radial turbine having a different blade configuration. As those skilled in the art will realize, different applications may well call for using different types of turbine stages. The particular design of the turbine geometry shown in FIG. 6 should properly be viewed as being only one example among many possibilities.

It is anticipated that some applications for turbo-generator 66 may require the use of some bleed gas from the high pressure stage. Accordingly, bleed outlet 53 is provided for first stage collector 49. Using a splitter or throttling valve allows a desired quantity of partially expanded working fluid to be extracted through this outlet and fed to a “feedwater” heater or other device (The term “feedwater heater” originated with steam cycles but is now used in cycles which do not employ water as a working fluid).

Working fluid which has expanded through low pressure stage 50 is collected in second stage collector 51 and fed out through turbine outlet 52. Cooling jacket 84 assumes the form of a helical fluid channel around the periphery of the turbine casing. Liquid working fluid—or a separate cooling medium—may optionally be pumped through this passage to cool the turbine. Those familiar with turbine design will realize that many more unillustrated components will be present in such a turbine. These include seals, insulating material, pressure sensors, and the like. These components have not been illustrated for purposes of visual clarity.

An electric generator occupies the space between the front and rear bearings in the embodiment shown. Homopolar motor 32 is used in this example. The rotor is formed by placing a magnetic substance (such as neodymium) on common shaft 30 itself. The magnetic substance may be formed as a sleeve around the rotor (not shown in FIG. 6).

The term “homopolar motor” is used to describe the components present. However, the device is actually being used as a generator. Rather than applying an electrical current to the common shaft in order to induce a useful torque, an external torque is being applied to the shaft by the turbine stages in order to induce a useful electrical current.

Many types of electrical generators could be used in the invention. A homopolar motor is well-suited to very high-rotational speeds. It is therefore a good choice. While a discussion of the operation of homopolar motors is beyond the scope of this disclosure, those skilled in the art will know that when an external torque and magnetic field are applied to common shaft 30 in the region denoted as homopolar motor 32, an electrical potential will be created in motor windings 82 (assuming that an appropriate contacting or inductive circuit is created with the rotor). A more complete discussion of the construction and control of homopolar motors is contained in U.S. Pat. No. 7,135,828 to Lin and U.S. Patent Pub. No. 2006/0125436 to Lin. These documents are hereby incorporated by reference.

Control electronics 54 may be housed as part of the integral unit of turbo-generator 66. More likely they will be remotely housed so that they are not subjected to the heat of the turbine. The power and control circuitry for the sensor rings and the magnetic bearings may be located together with the control electronics or may be separate. Cooling may be provided by circulating working fluid that has left the condenser around the motor, the control electronics, or both. Alternatively, a separate circulating coolant may be used.

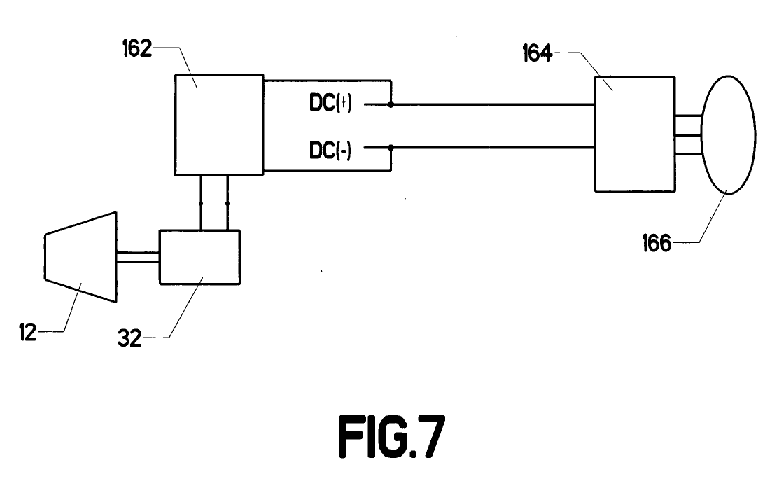

The output of the motor (generator) can assume many forms. One desirable form is three-phase alternating current. Another potentially useful form is simple DC. However, because an AC output allows the voltage to be changed more easily, it is preferred. It is even more desirable to make the output applicable to an existing power grid. FIG. 7 conceptually depicts components which can achieve this objective.

Turbine 12 is driven by expanding working fluid circulated in a heat recovery cycle. The spinning turbine drives homopolar motor 32. Output power electronics module 168 is connected to the stator windings. This module will typically include power-switching devices such as IGBT's. As one example, six IGBT's can be used to provide a 3-phase alternating current output.

The ultimate goal is to feed the electrical power being generated by homopolar motor 32 onto an existing AC grid 166. Of course, this will require voltage and phase matching. For example, the output of the output power electronics module might be 1,000 VAC at 200 Hz. This output is fed into rectifier 162, which preferably smoothes the signal as well as rectifying it. The rectifier may also be configured to step up or step down the input voltage as needed. The rectifier then feeds appropriate DC voltage to IGBT module 164.

IGBT module 164 likely includes multiple individual IGBT's under the control of suitable electronics. The control system monitors the voltage and phase on the AC grid (which is preferably a three-phase AC grid). The IGBT module then feeds appropriately phase and voltage matched electricity onto the grid and ultimately to electrical load 58.

Those skilled in the art will know that many techniques exist for providing a regulated AC output. One approach is to substitute a three-phase synchronous motor for the homopolar motor in the turbo-generator. Such a motor can directly produce relatively clean AC power. However, such a motor would also be limited to a fixed shaft operating speed (or a relatively small number of fixed shaft operating speeds). It is preferable to allow the turbo-generator to operate over a wide range of speeds so that it can be used for a variety of waste heat recovery operations without the need for redesign or adjustment. Some waste heat sources themselves will vary (such as a flare gas source) so the ability to vary the operating speed in a single application is also desirable. Thus, synchronous operation is less than optimal.

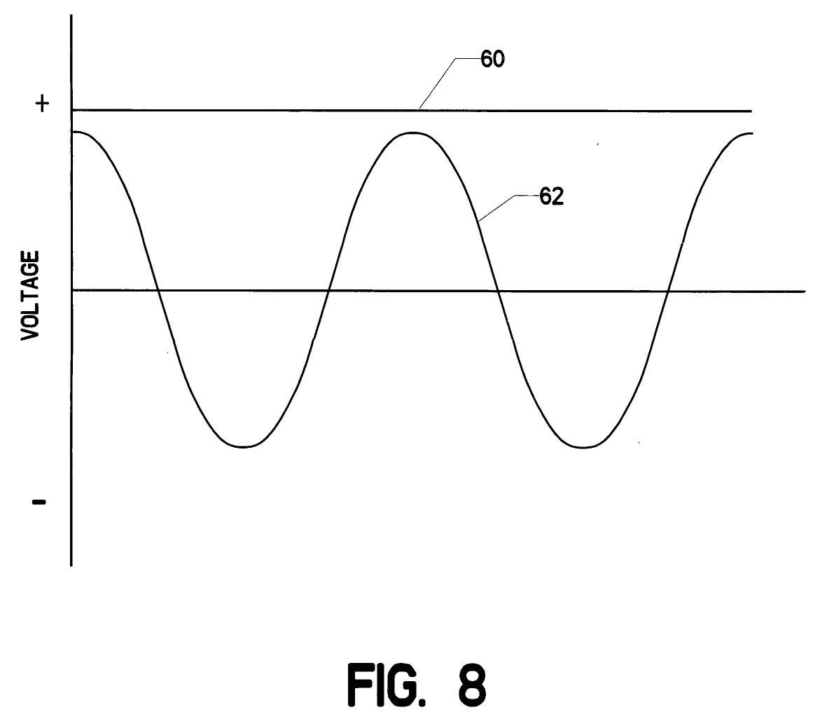

The detailed operation of IGBT module 164 is beyond the scope of this disclosure. However, the reader may benefit from a brief discussion of its operation with respect to a single AC phase. Modern power switching equipment—particularly IGBT's—allow DC current to be converted to AC current with a wide range of desired voltages and frequencies. A common type of DC to AC converter is a pulse width modulated inverter drive (referred to as a “PWM.”). FIG. 8 shows a voltage plot versus time. The output of rectifier 162 is preferably a steady state DC voltage (“60” in the view). Desired AC output 62 is a sinusoidal voltage having a desired frequency and amplitude. Thus, IGBT module 164 must take the steady DC input and create the desired sinusoidal output.

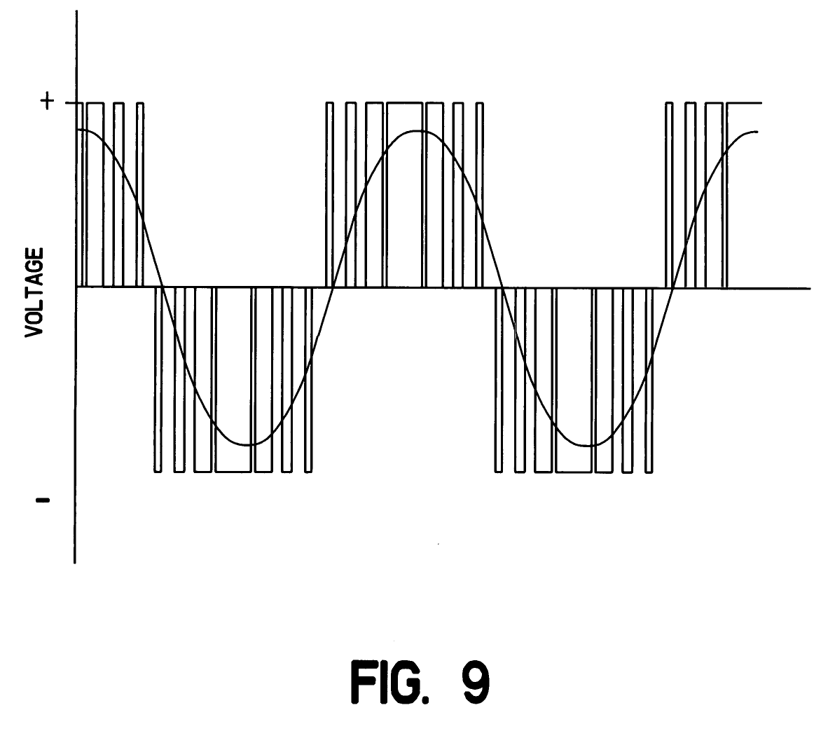

FIG. 9 shows the use of a PWM to “artificially” create a sinusoidal output voltage. A series of DC pulses 64 are created by the IGBT's. The same switching equipment can very rapidly reverse the polarity of the pulses. The pulse voltage is fixed, but the duration or dwell of each pulse can be varied or modulated (hence the name of the PWM).

The pulse train will not directly produce a smooth sinusoidal output as shown. Smoothing power filters—such as capacitive and inductive circuits—are generally needed to smooth the output. These may be passive devices but are now more commonly active devices with feed back and/or feed forward control loops.

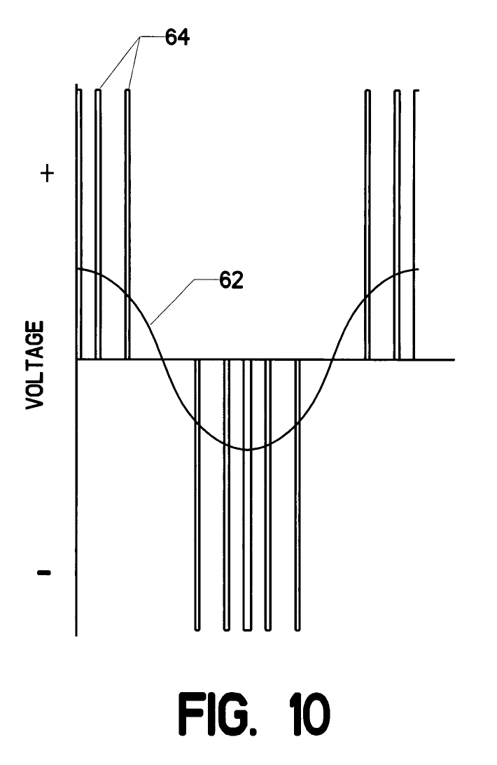

The timing of the applied pulses controls the phase of the output. The voltage of the output can be varied using pulse dwell. In FIG. 10, the DC input voltage is higher than the amplitude of the desired AC output. The PWM accounts for this fact by reducing the dwell of each pulse in the pulse train (and possibly reducing the number of pulses). The AC wave produced (after smoothing) therefore has an amplitude which is significantly below that of each individual pulse.

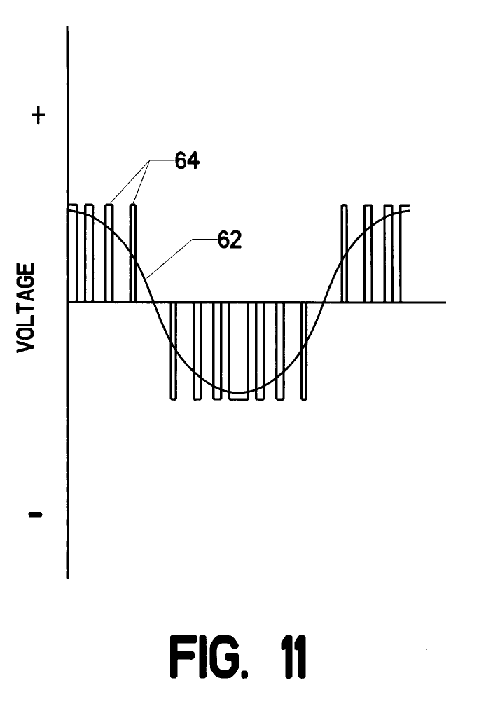

In FIG. 11, the input DC voltage and output AC amplitude are more closely matched. The PWM accounts for this variation by increasing the dwell of each pulse (and possibly increasing the number of pulses). The result is an AC output that has an amplitude very nearly matching the DC input voltage.

In any event, the reader will readily perceive that it is possible to produce an AC output of desired frequency and amplitude. Further, the phase of the AC output is a matter of choice, since the pulse train can be configured to “set” the zero crossing points of the AC output at any desired position. Thus, the output can be phase matched to an existing power grid and fed directly onto that grid.

These facts allow the turbo-generator to be made as a self-contained and modular unit. It can be connected to a Rankine cycle engine to feed it mechanical power. The electrical outputs can then be connected directly to a load it is to supply or a power grid it is to feed into. The turbo-generator may be equipped with its own grid voltage and phase-sensing devices so that it can self-regulate the power it produces, or the voltage and phase-sensing components may be housed separately.

If the turbo-generator is connected directly to an electrical load, it can also be equipped with a waste-gate for dumping system pressure around the turbine when some of the available power is not needed. This allows for rapid adjustment in the operating conditions. The input from the waste heat source can likewise be adjusted for periods when power production is not needed.

Using a sophisticated PWM it is also possible to produce different types of useful electrical output. As an example, when peak power is available, the PWM can produce 440V 3-phase electricity. As the available waste heat power tapers off, the electrical controls can adjust to produce 220V 1-phase electricity. The control electronics can also be configured to feed the 440V power onto a different grid or load than the 220V power.

The turbo-generator is preferably made compact and relatively light. It is preferably able to fit inside a 1 m cube and it preferably weighs less than 300 kg. These features allow the turbo-generator to be easily transported and installed. However, the small size and mass limit the flow rates of working fluid it can handle. Thus, it is important to make the device modular so that multiple turbo-generators can be configured to handle loads exceeding the capability of a single unit.

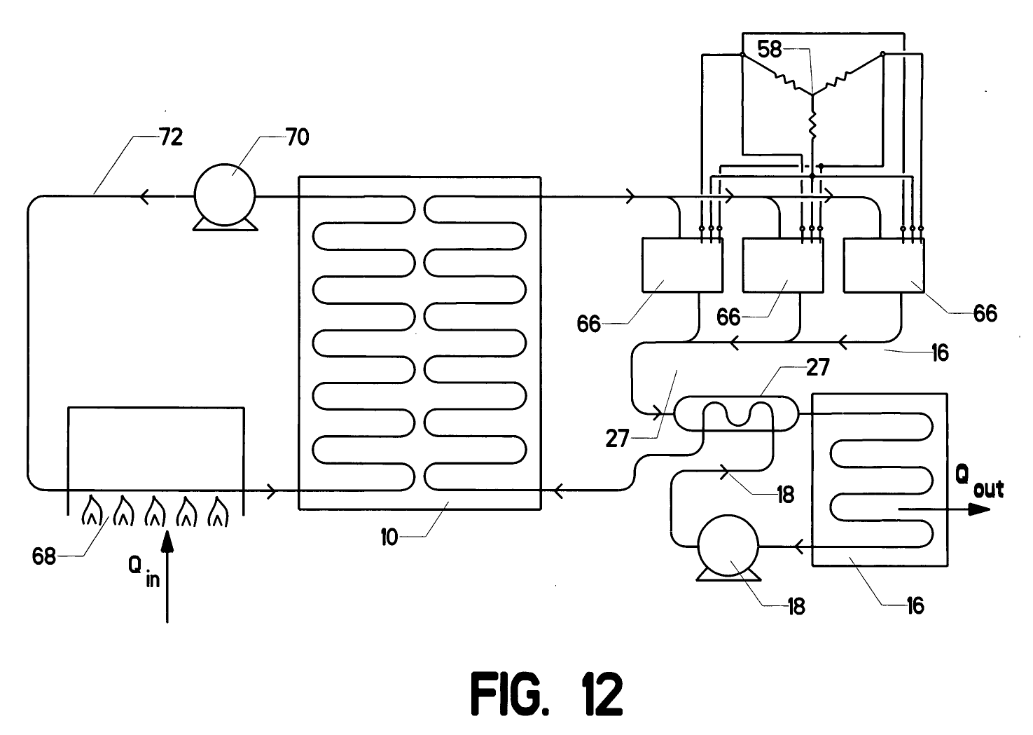

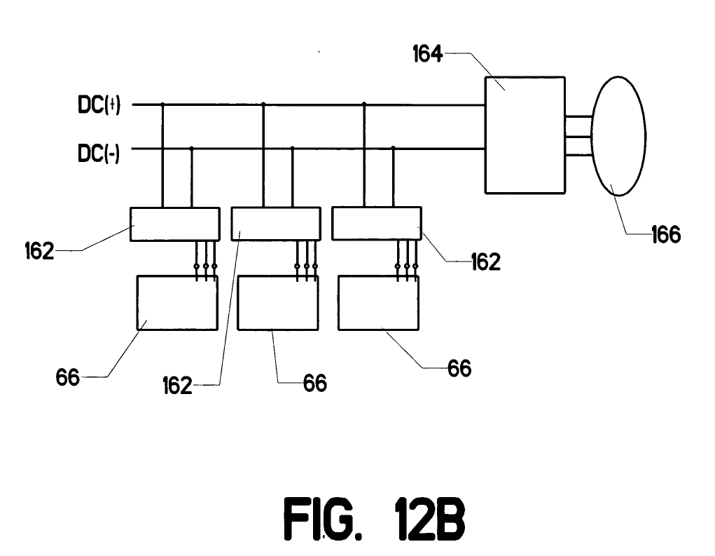

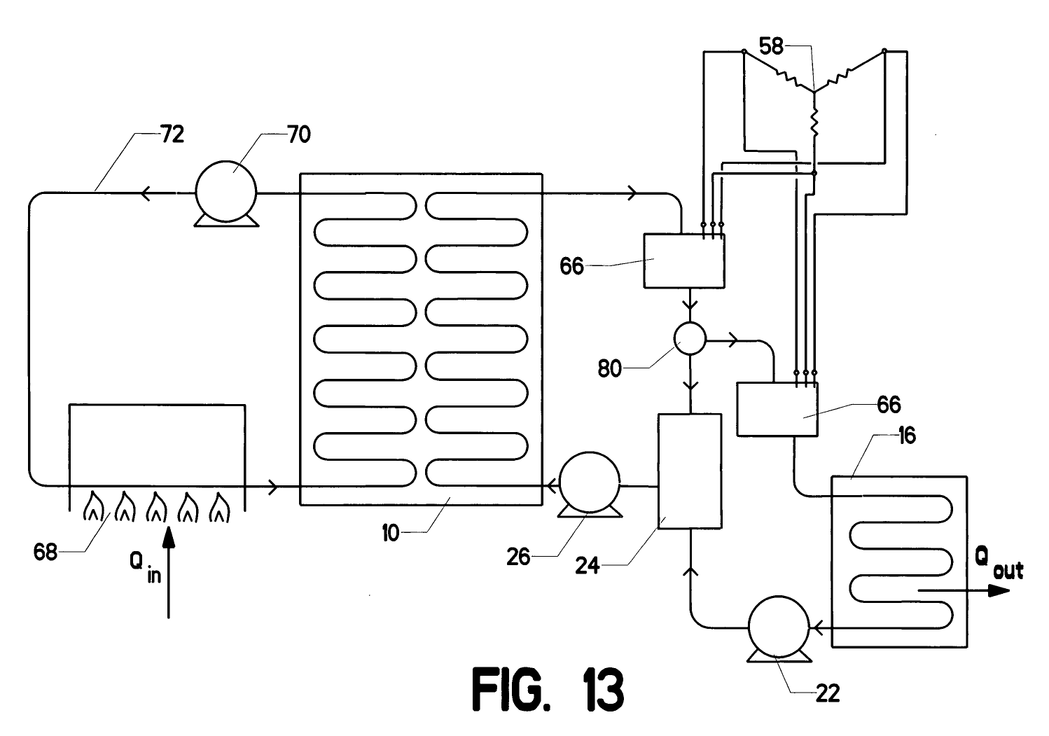

Having now received a thorough explanation of the turbo-generator itself, the reader may wish to learn how it can be incorporated into a Rankine cycle heat engine. FIGS. 12 and 13 provide a small sampling of the many possible installations. FIG. 12 shows a Rankine heat engine used for waste heat recovery. Waste heat is conveyed from waste heat source 68 to boiler 10 by circulation loop 72. Circulation loop 72 contains a circulating heat transport medium which is propelled by pump 70.

This particular heat engine is configured for a working fluid flow rate approximately three times the capability of a single turbo-generator. Thus, three turbo-generators 66 are connected in parallel. Superheated working fluid is generated by boiler 10 and expanded through the three turbo-generators 66. The expanded working fluid then passes through recuperator 27 and on to condenser 16 before being pressurized in pump 18.

The AC power output of the turbo-generators are all connected to electrical load 58, which can be an external power grid or actual powered device. The control electronics within each turbo-generator preferably perform their own determinations of the needed amplitude, frequency, and phase of the output voltage. The outputs of the three devices are thereby synchronized. Those skilled in the art will realize that all three turbo-generators may run at slightly different rotational velocities. However, the regulated outputs will ensure that all three provide as much a share of the load as possible.

Of course, in some applications, it may be desirable to provide a unified external control which can regulate the input pressures to each of the three turbines (via a dump valve or other means) in order to ensure even loading. Alternatively, the three turbines can be allowed to run at different speeds and the “matching” can be done electrically. FIG. 12B shows an example of this approach. The three turbo-generators 66 feed into three rectifiers 162. The three rectifiers 162 feed DC voltage onto the two rails shown. IGBT module 164 takes in this DC voltage and creates phase and voltage matched AC output which is then fed onto AC grid 166.

It is also possible to connect two or more turbo-generators in mechanical (rather than electrical) series. FIG. 13 shows such an arrangement. In this configuration, the first turbo-generator 66 acts as a compound “first expansion stage” and the second turbo-generator 66 acts as a compound “second expansion stage.” The expanded working fluid exiting the first turbo-generator enters splitter valve 80, where a portion is directed to feedwater heater 24 (Again, the term “feedwater heater” is generic and does not imply the presence of water in the working fluid). Another portion leaves the splitter valve and is further expanded through the second turbo-generator 66. This further expanded portion then passes through condenser 16. The working fluid leaving the condenser passes through low pressure pump 22, through feedwater heater 24, through high pressure pump 26, and then back to the boiler.

In such a machine the rotational speed of the two turbo-generators will almost certainly be different and may be substantially different. The PWM-driven output is therefore particularly important, since it will often be desirable to feed both outputs to a single electrical load. The approach depicted in FIG. 12B is useful for this circumstance as well. Alternatively, internal circuitry within each turbo-generator can phase, voltage, and amplitude-match the resulting AC output so that the two AC outputs can be fed onto a common source. Of course, one turbo-generator will likely supply a greater share of the electrical current than the other.

For purposes of simplicity the various illustrated thermodynamic cycles have been presented as distinct. Those skilled in the art will know that the various cycles are often mixed and matched together to create a particular working Rankine engine. As an example, the use of the common shaft to mount the turbine and the electrical motor in the turbo-generator may present cooling problems in some applications. It may therefore be necessary to route some or all of the compressed liquid working fluid leaving the pump through a cooling jacket surrounding the turbine casing. This would create a hybrid regenerative Rankine cycle. Returning to FIG. 6, the reader will observe that cooling jacket 84 has been provided, though it may not always be used.

### Internal Combustion Engine Applications

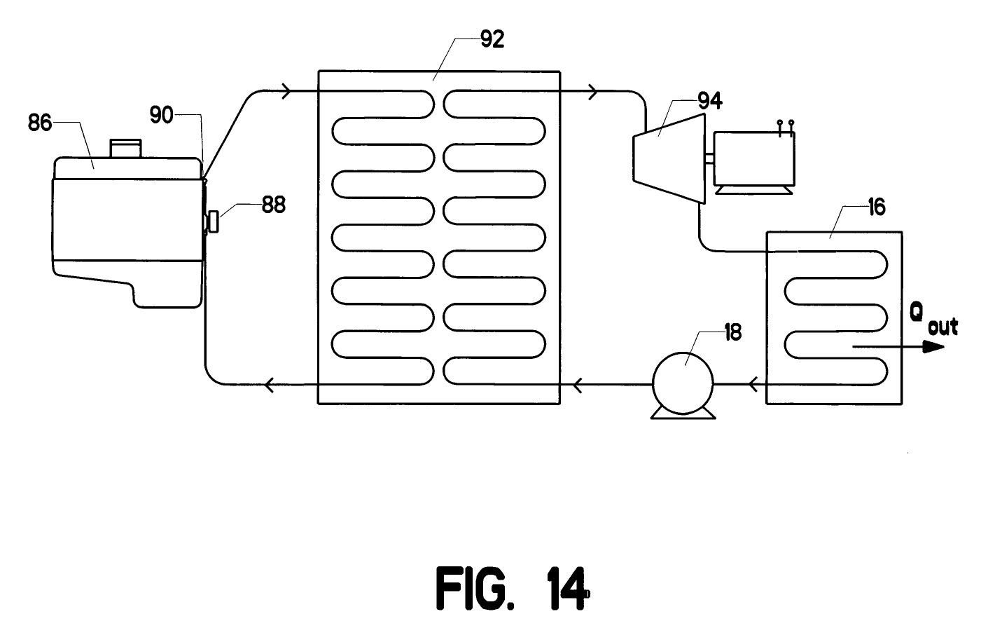

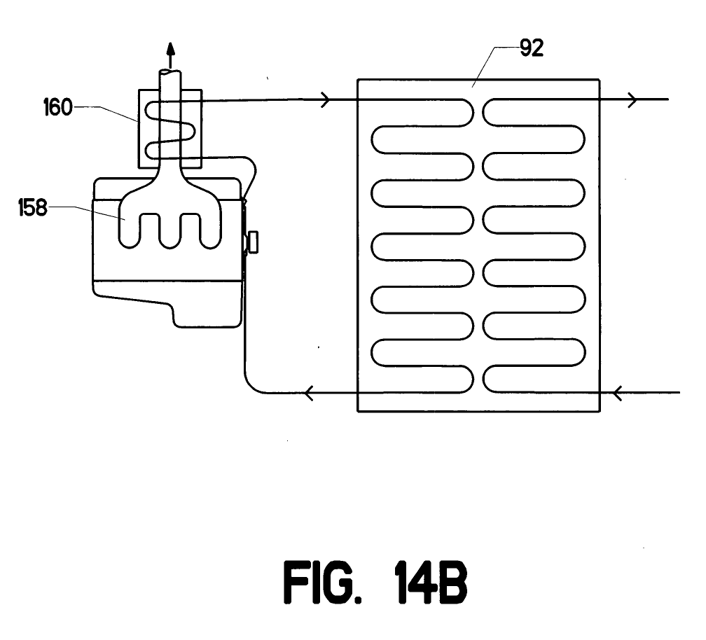

One good application for the proposed organic Rankine cycle using the efficient turbo-generator is the automotive industry. FIG. 14 schematically illustrates the use of “waste heat” from internal combustion engine 86. In this context, the term “waste heat” means the heat that must be removed from the engine to maintain an acceptable operating temperature.

A suitable working fluid is selected, as described previously. Coolant pump 88 is preferably driven by the internal combustion engine. It circulates the working fluid in a first circulation loop (the same type of loop as is used in conventional engine cooling). In fact, the working fluid may be a conventional water/anti-freeze mixture. The internal combustion engine includes one or more internal cooling passages having an inlet and an outlet.

Thermostat 90 recirculates the working fluid within the engine's internal cooling passage(s) until a suitable temperature is reached. It then opens, which sends the working fluid through heat exchanger/boiler 92. There the heat is transferred to the Rankine cycle fluid being circulated in a second circulation loop by pump 18. The fluid within the Rankine cycle loop is vaporized and fed into turbo-generator 94.

The turbo-generator 94 is a device which is conceptually similar to the turbo-generator of FIG. 6. It may be configured to produce AC power as explained previously or suitable DC power for the automotive application (The turbo-generator is one example of an electrical power generation device. There are of course other such devices). The turbo-generator may—for example—be substituted for the belt-driven alternator commonly found on automobiles. Once the vapor is expanded through the turbine it passes through condenser 16 and then back to pump 18. The turbo-generator may include a gas throttling device on the high pressure side of the turbine. This device can control the amount of gas circulating within the loop containing the turbine.

Of course, the expansion turbine can be used to feed mechanical power directly to the internal combustion engine instead of creating auxiliary electrical power. This can be done through a belt drive arrangement, a reduction gearbox, or other suitable means. As one example, the turbine can be mounted as an accessory on the front of the engine with a pulley connected to a serpentine belt driving the other accessories such as a power steering pump and an alternator. Such an arrangement might require a clutch for the turbine—or other suitable connecting components—but the arrangement would certainly be feasible. It is challenging to create a design in which the turbine directly drives a shaft which extends out of the housing. However, a magnetic or other suitable indirect coupling could be used for this purpose.

FIG. 14B shows an enhancement of the configuration of FIG. 14. Those skilled in the art will know that much of the waste heat of an internal combustion engine is rejected in the exhaust gases. Part of this energy may be recovered using a turbocharger, but much of it is still lost. In FIG. 14B exhaust manifold 158 feeds into exhaust heat exchanger 160. Heat is transferred from the exhaust to the circulating working fluid and then carried to heat exchanger boiler/92 as shown. This is illustrated as being part of the same cooling loop that passes through the engine itself (a “series” connection). However, the exhaust heat exchanger could be connected in parallel. It could also use a separate circulating pump and even a different working fluid.

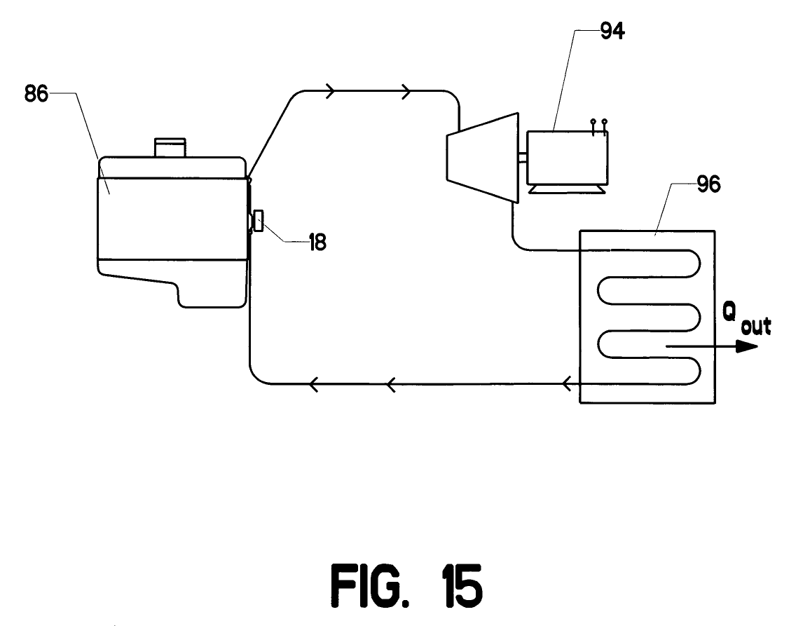

The embodiment shown in FIG. 14 is somewhat limited by the use of conventional engine coolant in a separate circulating loop. It is likely more efficient to use the internal combustion engine itself as the evaporator in a Rankine cycle engine. FIG. 15 shows an example of this approach. Pump 18 is preferably driven by the internal combustion engine itself—though this need not always be the case. It compresses the liquid refrigerant returning from condenser/radiator 96 and then feeds it into the internal cooling passage within the internal combustion engine. The pressurized refrigerant will undergo a phase change as it circulates and is preferably completely vaporized before it passes out of the engine and is conveyed to turbo-generator 94. A thermostat or other regulating means can be employed to control the refrigerant's circulation rate.

Because the Rankine cycle employs a phase change, a relatively small mass of refrigerant (in comparison to conventional engine coolant mass) will be needed. The expanded vapor leaving the turbo-generator returns to condenser/radiator 96 and then repeats the cycle. The condenser/radiator can occupy the space currently used by conventional water-filled radiators in current automobile designs.

An exhaust heat exchanger (as shown in FIG. 14B) can be incorporated in this embodiment as well, though a separate working fluid would likely be needed since a refrigerant suitable for cooling the engine would likely be unsuitable for use in the exhaust heat exchanger.

A turbo-generator for producing electrical power is illustrated in this embodiment, but the turbine can be used to power the same things as described for the embodiment of FIG. 14 (direct drive, intake air compression, etc.). Because of the inherent efficiency, the use of refrigerant to directly cool an internal combustion engine is desirable.

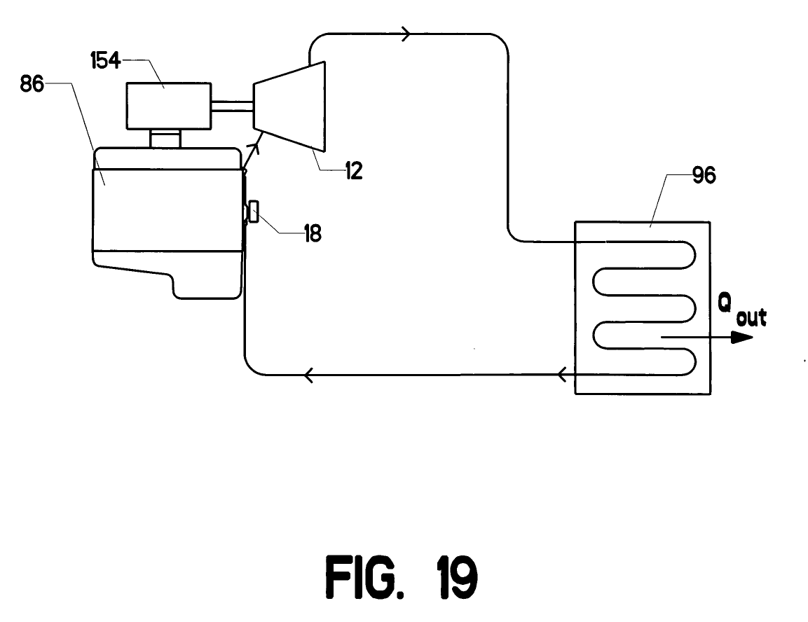

The turbine can even be used to drive an intake air compressor such as is done with exhaust-driven turbo-superchargers (though again, a directly coupled shaft is difficult to design because of the use of oilless bearings). FIG. 19 shows an embodiment using turbine 12 to directly power supercharger 154. This allows an increase in the charge density feeding into the internal combustion engine and a resulting increase in performance.

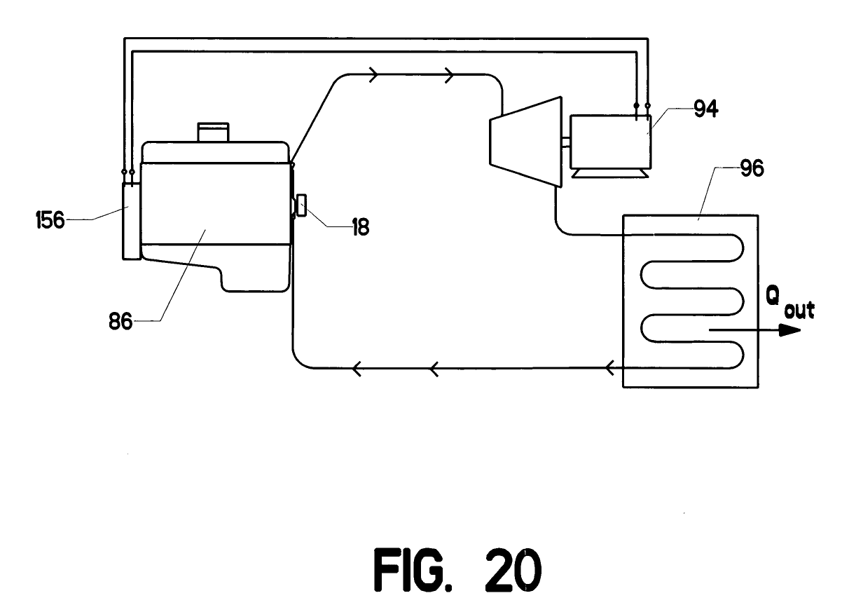

The recent development of hybrid fossil fuel/electric engines opens another possibility for efficient operation. These engines include a large electric motor which can use electricity stored in a battery (or possibly generated in a fuel cell) to directly apply mechanical torque to the flywheel or other suitable component. A “ring motor” mounted proximate the flywheel is a suitable example. FIG. 20 shows this embodiment. Ring motor 156 has been added to internal combustion engine 86. Turbo-generator 94 feeds electrical power directly to this ring motor.

### Rankine Cycle Embodiments Using Simplified Pumps

Prior art Rankine cycle engines have featured pumps to compress the condensed refrigerant and feed it back to the evaporator. The use of these pumps introduce a certain measure of inefficiency. They add complexity as well and tend to make the overall system less reliable. However—in traditional thinking—there has been simply no way to eliminate the need for the pump. The evaporator is typically thought of as the high pressure side of the system and the condenser is thought of as the low pressure side. Refrigerant exiting the condenser must be moved from the low pressure side to the high pressure side in order to keep the loop circulating. The pump has traditionally fulfilled this need.

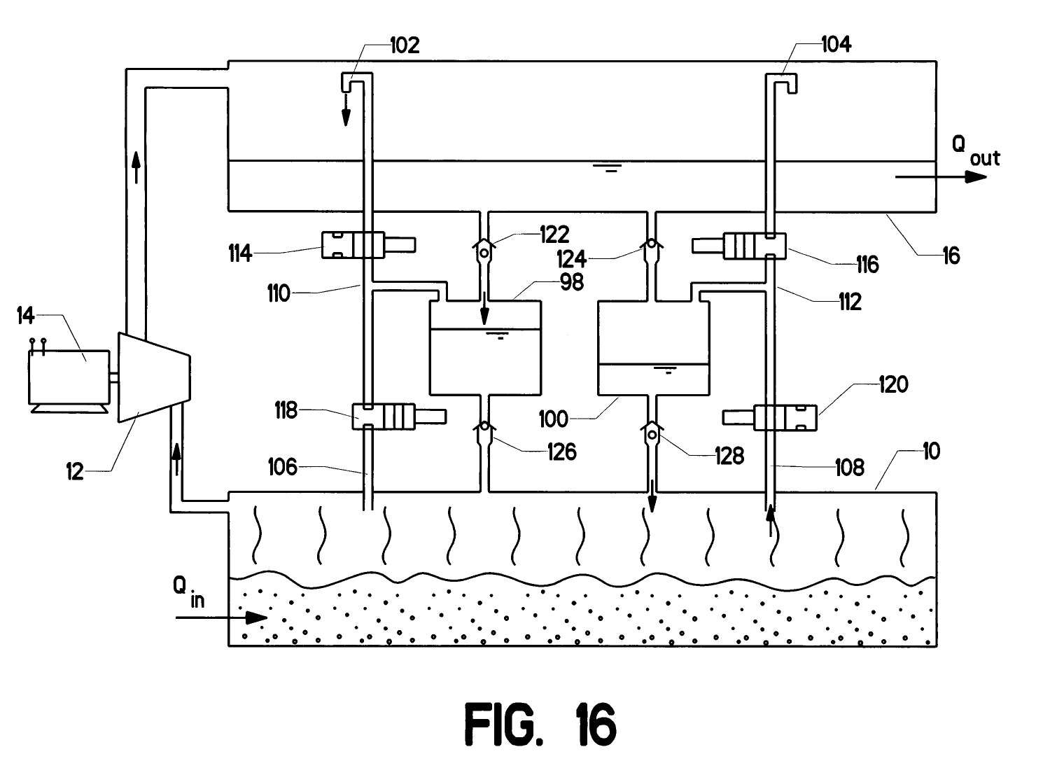

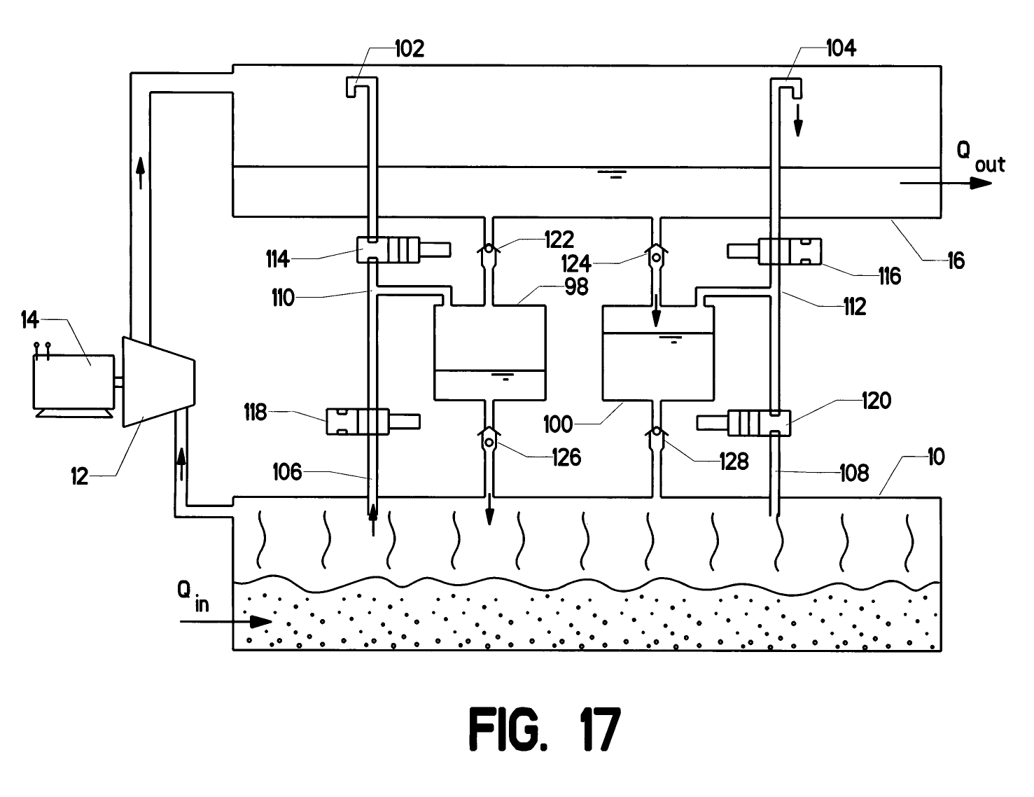

FIGS. 16 and 17 represent a new type of Rankine cycle in which the conventional pump is eliminated. This new type of Rankine cycle proposes to feed the working fluid (such as a refrigerant) from the condenser back to the evaporator using gravity and/or available pressure. The heat engine of FIG. 16 includes a condenser 16 and a boiler 10 (which is another name for an evaporator). Heat is added to the boiler from any suitable source, including a waste heat source. Condenser 16 sheds heat to condense the circulating refrigerant. The boiler and the condenser preferably include conventional features such as serpentine flow paths, cooling fins, etc. They are depicted as simple tanks in the schematic view because this is all the detail that is needed to understand the operation of the pumping system.

In a conventional system, a return line from the condenser would lead to a pump, which would then pressurize the refrigerant and thereby force it back into the boiler. In the embodiment of FIGS. 16 and 17, the pump is replaced by a pair of transfer tanks—first transfer tank 98 and second transfer tank 100. A single tank could be used, but at least two tanks are preferred for reasons that will be made apparent subsequently.

In the example of FIG. 16, condenser is higher than the transfer tanks, which are higher than the boiler. This approach uses gravity to assist in the transfer. First transfer tank 98 is connected via a first conduit to condenser 16. Flow in this line is governed by first check valve 122. The first transfer tank is also connected via a second conduit to boiler 10, with flow in this line being governed by third check valve 126.

The upper portion of first transfer tank 98 is connected to first tee 110. The first tee splits into first vent line 102 and first pressure line 106. The first vent line is regulated by first vent valve 114, which is movable between an open and a closed position. The first pressure line is regulated by first pressure valve 118. These valves are shown as solenoid operated two-position valves, but any suitable valve which operates to selectively open and close a line could be used.

The operation of the device will now be explained with respect to the first transfer tank only. In the state shown in FIG. 16, first vent valve 114 is open and first pressure valve 118 is closed. Because the pressure within boiler 10 is higher than the pressure in condenser 16 (and consequently first transfer tank 98), third check valve 126 is closed. First check valve 122 opens under the influence of gravity and refrigerant within the condenser flows down into first transfer tank 98, as shown by the arrow.

A suitable liquid level sensor is used to determine when the first transfer tank is full. At this point, first vent valve 114 is closed and first pressure valve 118 opens. This state is shown in FIG. 17. The higher boiler pressure is applied to first transfer tank 98. This closes check valve 122. The pressure within the boiler and the first transfer tank are then equalized. The liquid refrigerant within the first transfer tank then flows down through third check valve 126 under the influence of gravity. The reader will thereby perceive how via the operation of two controlled valves and two passive check valves refrigerant has been transferred from the low pressure side of the system to the high pressure side without the use of conventional pumps.

Of course, using a single transfer would likely cause excessive fluctuations in the flow through the circulating loop. It is therefore desirable to use more than one transfer tank. Returning to FIG. 16, the reader will observe the presence of second transfer tank 100. This is connected to the condenser via send check valve 124 and to the boiler via fourth check valve 128. Its upper portion is connected to second tee 112, which splits into send vent line 104 and second pressure line 108. The second vent line is controlled by second vent valve 116. The second pressure line is controlled by second pressure valve 120.

The reader will note that the valves connected to the second transfer tank are out of phase with those connected to the first transfer tank. In FIG. 16, second pressure valve 120 is open while second vent valve 116 is closed. Second check valve 124 is closed while fourth check valve 128 is open. The refrigerant within the second transfer tank is therefore flowing down into the boiler under the influence of gravity.

Turning again to FIG. 17, the reader will note that the second transfer tank is filling while the first transfer tank is discharging. Thus—by operating the two sets of valves, one transfer tank will be filling while the other is emptying. If the valves, transfer tanks, and conduits are properly sized, a reasonably steady flow of refrigerant can be maintained. Of course, the system is not limited to only two transfer tanks. Three, four, or more transfer tanks may be preferable in some applications.

The embodiment of FIGS. 16 and 17 likely works best when the condenser is above the boiler. However, this need not always be the case. Subcooling can provide sufficient lift for the system to work even when the boiler is placed above the condenser.

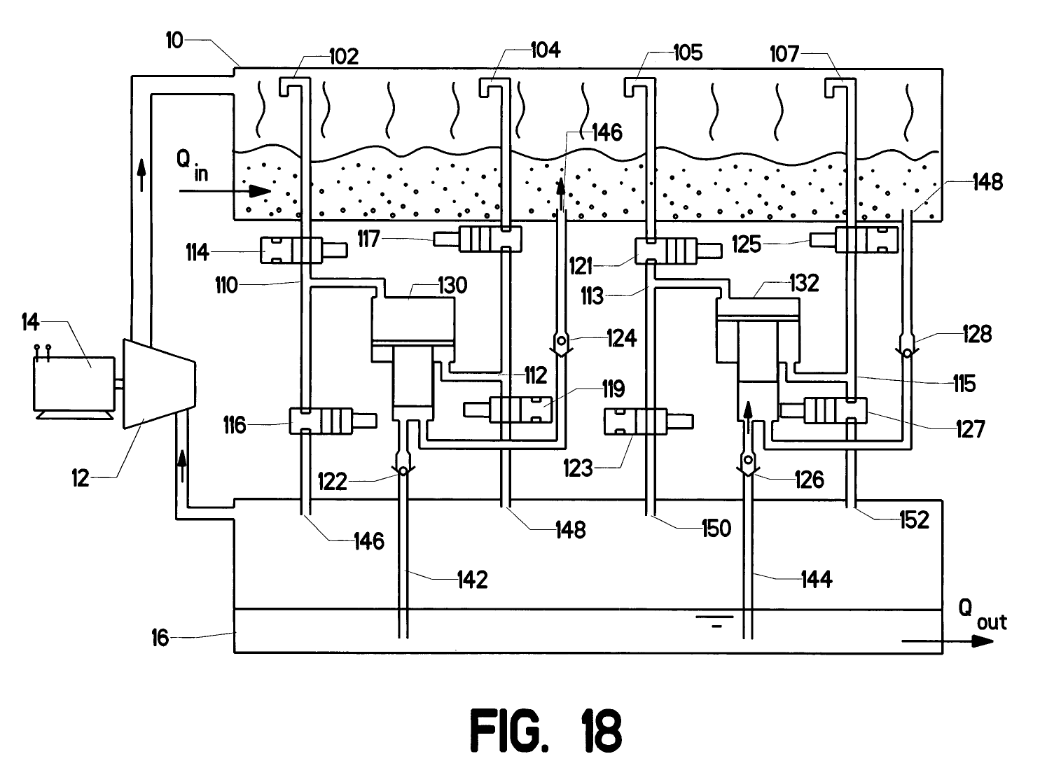

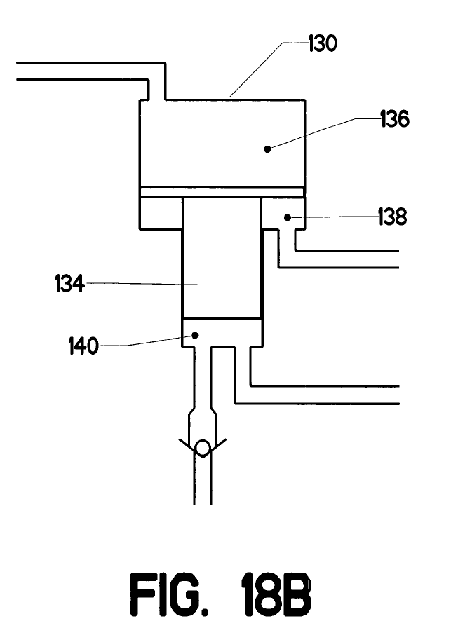

FIGS. 18 through 19 illustrate an alternate approach using area differential pistons. In FIG. 18, boiler 16 sits above condenser 18. First piston pump 130 is used to lift the refrigerant from the condenser to the boiler. FIG. 18B shows this piston pump in more detail. The piston pump has a first piston 133 linked to a second piston 134. The surface area of the first piston is greater than the surface area of the second piston. This fact is significant to the operation of the device, as will be made apparent subsequently.

First chamber 136 lies on a first side of first piston 133, and second chamber 138 lies on the opposite side. Third chamber 140 is bounded by a fixed end wall and the movable second piston 134. Turning back to FIG. 18, the reader will appreciate how the first piston pump fits into the broader device. First vent valve 114 is open, which connects first vent line 102 to first chamber 136 (via first tee 110). Second vent valve 116 and third vent valve 117 are closed. Fourth vent valve 119 is open, which connects second chamber 138 to sixth vent line 148 (via second tee 112).

In this configuration of the valves, the pressure within the boiler is applied to first piston 133. The “back side” of first piston 133 faces second chamber 138—which is at the pressure of the condenser. Because the surface area of first piston 133 is greater than the surface area of second piston 134 (the surface area of the portion facing third chamber 140), the pressure within third chamber 140 is higher than the pressure within the boiler. This pressure difference causes second check valve 124 to pop open, after which the refrigerant within the third chamber of first piston pump 130 is expelled into the boiler through first discharge line 146. First check valve 122 is held closed so that no backflow occurs. Thus, the reader will appreciate that the embodiment of FIGS. 18-19 can pump the refrigerant “uphill” from the condenser and back to the boiler.

Of course, it is desirable to use multiple pumps to make the flow more even. FIG. 18 also shows second piston pump 132, which is identical to the first piston pump. The second piston pump is connected to third tee 113 and fourth tee 115. Fifth vent valve 121 connects third vent line 105 to third tee 113, while sixth vent valve 123 connects third tee 113 to seventh vent line 150. Seventh vent line 125 connects fourth tee 115 to fourth vent line 107, while eighth vent valve 127 connects fourth tee 115 to eighth vent line 152.

In the configuration shown in FIG. 18, sixth vent valve 123 and seventh vent valve 125 are open. Fifth vent valve 121 and eighth vent valve 127 are closed. Boiler pressure is thereby applied to second chamber 138 of second piston pump 132, while condenser pressure is applied to the first chamber. This causes the pistons to move upward (with respect to the orientation shown in the view). Third check valve 126 pops open and liquid refrigerant is pulled up from the condenser into third chamber 140 of second piston pump 132. Fourth check valve 128 is held closed.

Thus, the reader will appreciate that first piston pump 130 is discharging while second piston pump 132 is loading. The valve sets are preferably controlled so that the two piston pumps remain out of phase. Liquid level sensors are preferably used to control the cycles. The components are ideally configured so that as the first piston pump completes its discharge cycle the second piston pump is fully loaded. The state of each controllable valve in the valve sets is then reversed and the first piston pump begins loading and the second piston pump begins discharging. As for the prior embodiment, three or more such pumps could be used in some applications.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. As an example, although the components have been described as being used with various organic working fluids (such as R-245fa), the high turbine rotational speeds permitted by the turbo-generator may allow the use of low molecular weight working fluids in some circumstances, including steam. As a second example, the use of the name “Rankine cycle” to describe the heat engines disclosed in the specification should not be viewed as limiting. The devices and methods disclosed could use other known thermodynamic cycles, with the Rankine cycle merely being a preferred embodiment.

Although specific terms may be employed herein, they are used in a generic and descriptive sense only and not for purposes of limitation. Accordingly, the present invention is not limited to the specific embodiments illustrated herein, but is limited only by the following claims.

Having described my invention, I claim:

1. A method for cooling an internal combustion engine and providing auxiliary power, comprising:
a. providing an internal combustion engine, having an internal cooling passage;
b. wherein said internal cooling passage has an inlet and an outlet;
c. providing a circulation loop connected to said inlet and said outlet of said internal cooling passage;
d. providing an expansion turbine in said circulation loop;
e. providing a condenser in said circulation loop, said condenser being located between said expansion turbine and said inlet of said internal cooling passage;
f. providing a refrigerant within said circulation loop; and
g. circulating said refrigerant within said circulation loop so that heat provided by said internal combustion engine changes said refrigerant from a liquid to a gas, thereby cooling said internal combustion engine and wherein said gaseous refrigerant is expanded through said turbine, thereby producing auxiliary power.

2. A method for cooling an internal combustion engine and providing auxiliary power as recited in claim 1, further comprising:
a. providing a pump within said circulation loop, wherein said pump circulates said refrigerant; and
b. connecting said pump to said internal combustion engine so that said internal combustion engine powers said pump.

3. A method for cooling an internal combustion engine and providing auxiliary power as recited in claim 2, further comprising providing a thermostat between said internal cooling passage and said circulation loop, wherein said thermostat controls the flow of refrigerant between said internal cooling passage and said circulation loop.

4. A method for cooling an internal combustion engine and providing auxiliary power as recited in claim 1, further comprising providing an electrical power generator connected to said turbine, so that said auxiliary power is generated by said electrical power generator as said turbine spins.

5. A method for cooling an internal combustion engine and providing auxiliary power as recited in claim 1, further comprising:
a. providing a supercharger for compressing the intake charge coming into said internal combustion engine; and
b. providing a connection between said turbine and said supercharger, so that as said turbine spins said turbine provides power to said supercharger.

6. A method for cooling an internal combustion engine and providing auxiliary power as recited in claim 1, further comprising providing a mechanical drive connection between said turbine and said internal combustion engine, so that as said turbine spins said turbine provides power to said internal combustion engine.

7. A method for cooling an internal combustion engine and providing auxiliary power as recited in claim 1, further comprising:
a. providing said turbine with a central shaft supported by oilless bearings configures to maintain a predetermined spacing between rotating and stationary bearing surfaces; and
b. providing said central shaft with an axial locating device to prevent axial movement thereof.

8. A method for cooling an internal combustion engine and providing auxiliary power as recited in claim 7, further comprising providing said turbine with a gas throttle positioned to regulate the flow of said gaseous refrigerant into said turbine, thereby regulating the flow of said refrigerant within said circulation loop.

9. A method for cooling an internal combustion engine and providing auxiliary power as recited in claim 4, further comprising:
a. providing a cooling passageway within said electrical power generator; and
b. passing said refrigerant through said cooling passageway in said electrical power generator in order to cool said electrical power generator.

10. A method for cooling an internal combustion engine and providing auxiliary power as recited in claim 4, further comprising:
a. providing an electric motor which is mechanically connected to said internal combustion engine so that motive force provided by said electric motor can be applied to said internal combustion engine; and
b. electrically connecting said electric motor to said electrical power generator so that electrical power generated by said electrical power generator feeds said electric motor.

11. A method for cooling an internal combustion engine and providing auxiliary power, comprising:
a. providing an internal combustion engine, having an internal cooling passage;
b. wherein said internal cooling passage is connected to a first circulation loop;
c. providing a heat exchanger in said first circulation loop;
d. providing a second circulation loop, wherein said second circulation loop passes through said heat exchanger;
e. providing an expansion turbine in said second circulation loop;
f. providing a refrigerant within said second circulation loop;
g. providing a coolant within said first circulation loop;
h. providing a condenser in said second circulation loop, said condenser being located so that said refrigerant circulating in said second circulation loop passes through said condenser after it has passed through said expansion turbine;
i. circulating said coolant within said first circulation loop so that heat is transferred from said internal combustion engine to said heat exchanger;
j. circulating said refrigerant within said second circulation loop so that heat is transferred from said heat exchanger to said refrigerant thereby changing said refrigerant from a liquid to a gas, thereby cooling said internal combustion engine and wherein said gaseous refrigerant is expanded through said turbine, thereby producing auxiliary power.

12. A method for cooling an internal combustion engine and providing auxiliary power as recited in claim 11, further comprising:
a. providing a first pump within said first circulation loop, wherein said first pump circulates said coolant;
b. providing a second pump within said second circulation loop, wherein said second pump circulates said refrigerant; and
c. connecting said first and second pumps to said internal combustion engine so that said internal combustion engine powers said pumps.

13. A method for cooling an internal combustion engine and providing auxiliary power as recited in claim 12, further comprising providing a thermostat within said first circulation loop, wherein said thermostat controls the flow of coolant within said first circulation loop.

14. A method for cooling an internal combustion engine and providing auxiliary power as recited in claim 11, further comprising providing an electrical power generator connected to said turbine, so that said auxiliary power is generated by said electrical power generator as said turbine spins.

15. A method for cooling an internal combustion engine and providing auxiliary power as recited in claim 11, further comprising:
a. providing a supercharger for compressing the intake charge coming into said internal combustion engine; and
b. providing a connection between said turbine and said supercharger, so that as said turbine spins said turbine provides power to said supercharger.

16. A method for cooling an internal combustion engine and providing auxiliary power as recited in claim 11, further comprising providing a mechanical drive connection between said turbine and said internal combustion engine, so that as said turbine spins said turbine provides power to said internal combustion engine.

17. A method for cooling an internal combustion engine and providing auxiliary power as recited in claim 11, further comprising:
a. providing said turbine with a central shaft supported by oilless bearings configured to maintain a predetermined spacing between rotating and stationary bearing surfaces; and
b. providing said central shaft with an axial locating device to prevent axial movement thereof.

18. A method for cooling an internal combustion engine and providing auxiliary power as recited in claim 17, further comprising providing said turbine with a gas throttle positioned to regulate the flow of said gaseous refrigerant into said turbine, thereby regulating the flow of said refrigerant within said circulation loop.

19. A method for cooling an internal combustion engine and providing auxiliary power as recited in claim 14, further comprising:
a. providing a cooling passageway within said electrical power generator; and
b. passing said refrigerant through said cooling passageway in said electrical power generator in order to cool said electrical power generator.

20. A method for cooling an internal combustion engine and providing auxiliary power as recited in claim 14, further comprising:
a. providing an electric motor which is mechanically connected to said internal combustion engine so that motive force provided by said electric motor can be applied to said internal combustion engine; and
b. electrically connecting said electric motor to said electrical power generator so that electrical power generated by said electrical power generator feeds said electric motor.
